(19) United States
(12) Patent Application Publication
(10) Pub. No.: US 2010/0304117 A1
(43) Pub. Date: Dec. 2, 2010

(54) METHOD OF FORMATION OF REINFORCEMENT MESH

(76) Inventors: Jon Robert Scott, Queensland (AU); Andrew Anthony Richards, Queensland (AU)

Correspondence Address: Sean P. O'Hanlon, Esq., PLLC, 460 S. Union Street, Alexandria, VA, 22314, US

(21) Appl. No.: 12/745,640

(22) PCT Filed: Dec. 3, 2008
(86) PCT No.: PCT/AU08/01786

§ 371 Date: Jun. 1, 2010

(30) Foreign Application Priority Data
Dec. 3, 2007 (AU) 2007906586
Jul. 28, 2008 (AU) 2008903839

(51) Int. Cl. B32B 5/02; B21F 27/08; B32B 7/08

(52) U.S. Cl. 428/223; 140/7; 140/11; 442/1

(57) ABSTRACT

The formation of reinforcement mesh which includes the steps of attaching intersecting filaments (11, 12) to each other using a bottom support (13, 13A, 13B, 13C, 31, 60) and a top support (10, 30, 50) wherein each of said filaments (11, 12) at a point of intersection is integrally moulded with the bottom support (13, 13A, 13B, 13C, 31, 60) and/or top support (10, 30, 50) or alternatively is supported by the bottom support (13, 13A, 13B, 13C, 31, 60) or top support (10, 30, 50) in a clipped or clamped relationship and attaching the bottom support (13, 13A, 13B, 13C, 31, 60) and top support (10, 30, 50) to each other to form the sheet of reinforcement mesh.

This invention relates to a method of formation of reinforcement mesh formed from intersecting filaments.

A method of formation of intersecting filaments of reinforcement mesh made from plastics material is described in International Publication WO 2007/051253 and is based on using integral supports which are integrally moulded with each intersecting filament at the point or location of intersection. This method also had clips which were integral or moulded with each filament at locations spaced from the intersection location so that adjacent sheets of mesh could be attached to each other in overlapping relationship. However, it was found in attaching mesh sheets in overlapping relationship that in the case of a three sheet or four sheet overlap that in some cases when forming a concrete slab which was to be reinforced by the three sheet or four sheet overlap mesh that the mesh could protrude through a top or bottom surface of the concrete slab and this was most undesirable.

A method of connection of intersecting filaments of a reinforcement mesh is described in U.S. Pat. No. 4,618,385 which refers to a method of commencing with a starting material having substantially parallel lines of holes or depressions defining elongate side by side main zones between the lines of holes or depressions and intermediate zones between holes or depressions in each line. The starting material is then drawn in a direction parallel to the main zones while preventing contraction in the direction at right angles to the drawing direction. The main zones are thus stretched into orientated main strands with the orientation extending from end to end and generally parallel to the drawing direction. This decreases the width of the main zones when forming the main strands. Simultaneously the intermediate zones are stretched between the main zones in a direction at a large angle to the direction of drawing. In the resulting mesh structure orientated interconnecting strands, formed from the intermediate zones, interconnect the main strands with the orientation in the interconnecting strands extending at a large angle to the main strands.

Thus, in this reference the mesh is formed by a drawing and stretching procedure to form mesh structure formed from plastics material which is complicated requiring expensive production machinery.

It is also commonplace to support mesh sheets with bar chairs which are purpose made plastics or steel supports usually having notches or recesses for supporting adjacent filaments. Such bar chairs are described for example in Australian specifications 20013579, 199944587, 735297, 686545, 671734 and U.S. Pat. Nos. 6,883,289 and 6,282,860. However, in this case the mesh filaments were welded to each other at their points of intersection and being formed from metal (also known as “re-bar”) were supported by the bar chairs. However, use of rebar which was supported by bar chairs as described above was often time consuming in installation because when using individual bar chairs it was often necessary to adjust each bar chair so as to have the same height above the ground or support surface.

It is therefore an object of the invention to provide a method of formation of reinforcement mesh which may alleviate the abovementioned disadvantages of the prior art.

The method of the invention includes the following steps:

(i) attaching intersecting filaments to each other using a bottom support and top support wherein each of said filaments at a point of intersection is integrally moulded with the bottom support or top support or alternatively is supported by the bottom support or top support in a clipped or clamped relationship; and

(ii) attaching the bottom support and top support to each other to form said sheet of reinforcement mesh.

Preferably adjacent sheets of intersecting filaments are attached to each other in a single plane.

More preferably adjacent ends of adjoining layers or sheets of mesh formed by step (ii) may be attached to each by using ties or clamps or clips.

In step (i) ideally each of the intersecting filaments are formed from fibre reinforcement plastics material which is plastics material such as epoxy, polyester, vinyl ester or nylon reinforced with glass fibres or carbon or graphite fibres. Other reinforcement may be with Kevlar or aluminium. In general the intersecting filaments may be formed from composite materials having a polymer matrix reinforced with fibres and these are known as FRPs generally exemplified by fibreglass.

Use may be made of metal or steel intersecting filaments although this is less preferred. Use may also be made of filaments formed from plastics material comprising high density polyethylene or low density polyethylene, polypropylene, polyester or polyamide or copolymers thereof.

However, the preferred material for use in the present invention is FRP or fibre reinforced plastics inclusive of carbon fibre but more preferably glass fibre.

In step (i) a lower filament and upper filament are preferably engaged to each other using the bottom support or top support which engages the lower filament and an upper filament. Preferably each of the top and bottom supports have retaining grooves for retaining their adjacent filament and in a preferred arrangement the bottom support is provided with a continuous retaining groove for retaining the lower filament and also a pair of opposed grooves of shallower depth for retaining the upper filament. In this embodiment the top support may be provided with a single retaining groove parallel with the pair of opposed grooves in use for retaining the upper filament.

In another arrangement the top support may have an upper groove and a pair of lower grooves for engaging the lower and upper filament. In this arrangement the upper groove may have a greater depth than each of the lower grooves.

It is also preferred that each of the bottom and top supports have a planar surface or plate-like body which has a plurality of spigots or sockets. Thus, the top support will preferably have attachment sockets or spigots which engage with corresponding attachment spigots or sockets of the bottom support. A spigot may engage with a corresponding socket in male/female or spigot and socket relationship by snap fit or interference fit to thus complete attachment of the support filament with the lower filament.

Reference may be made to a preferred embodiment of the invention as shown in the attached drawings wherein:

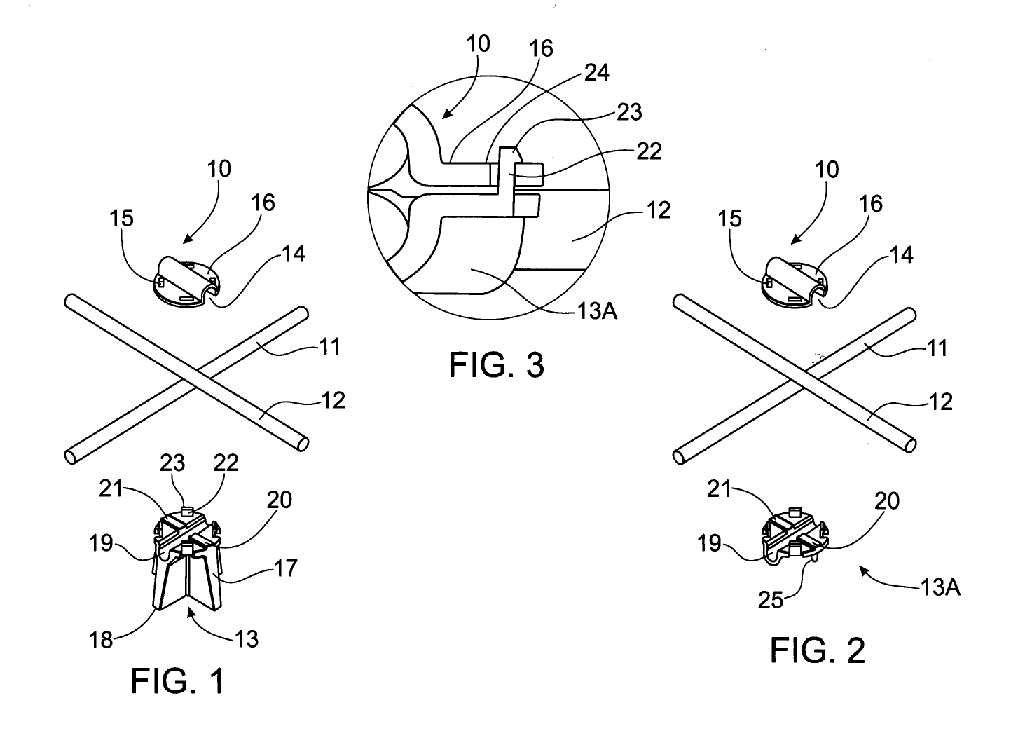

FIG. 1 is an exploded perspective view of connection method of intersecting filaments of the invention;

FIG. 2 is a similar view to FIG. 1 showing a modification of the connection method used in FIG. 1;

FIG. 3 is a detailed view of how the upstanding projections of the bottom support attach to the corresponding sockets of the top support;

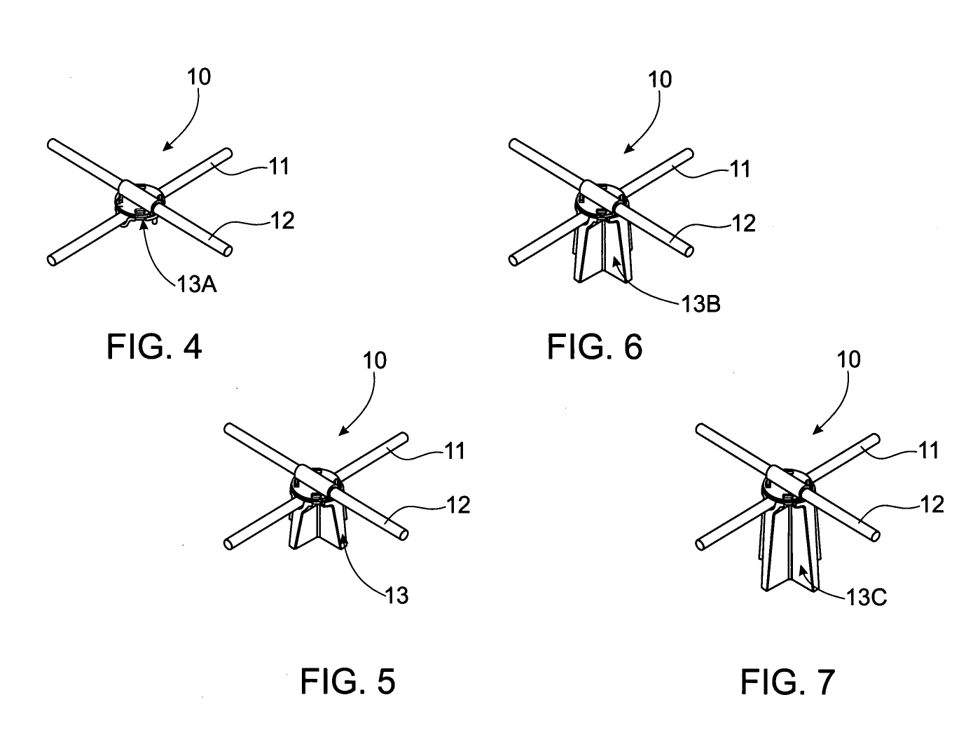

FIG. 4 is an assembled view of the connection method shown in FIG. 2;

FIG. 5 is an assembled view of the connection method shown in FIG. 1 applied to a 50 mm bar chair;

FIG. 6 is a view similar to FIG. 5 applied to a 75 mm bar chair; and

FIG. 7 is a view similar to FIG. 5 applied to a 100 mm bar chair.

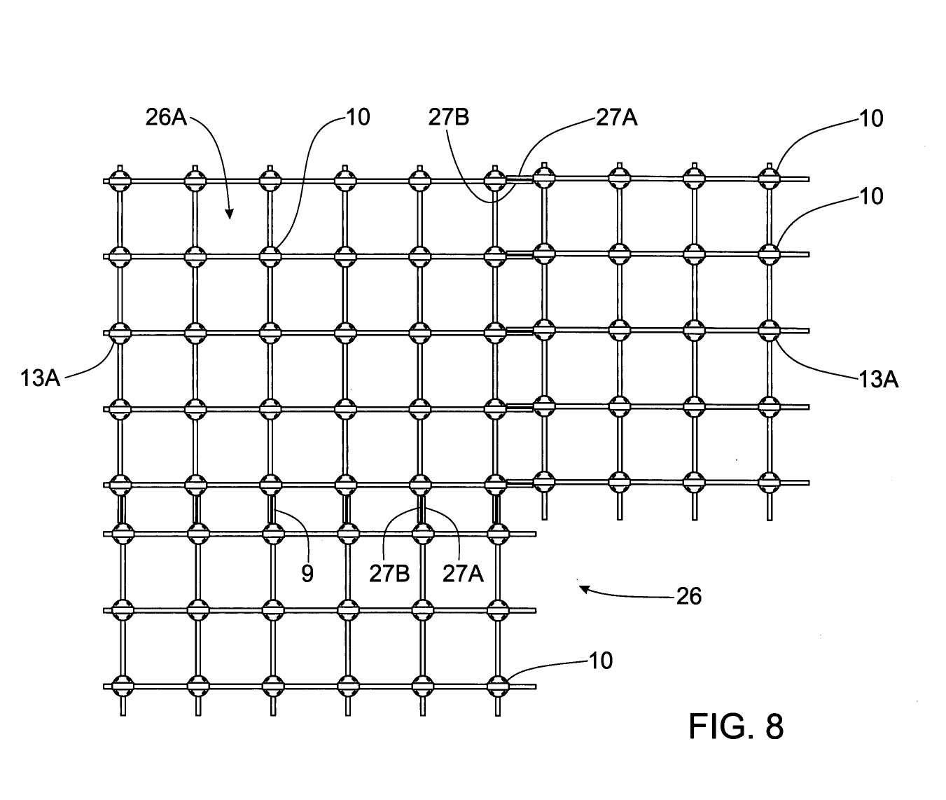

FIG. 8 is a view of a sheet of reinforcement mesh forced by the method of the invention shown in FIG. 1;

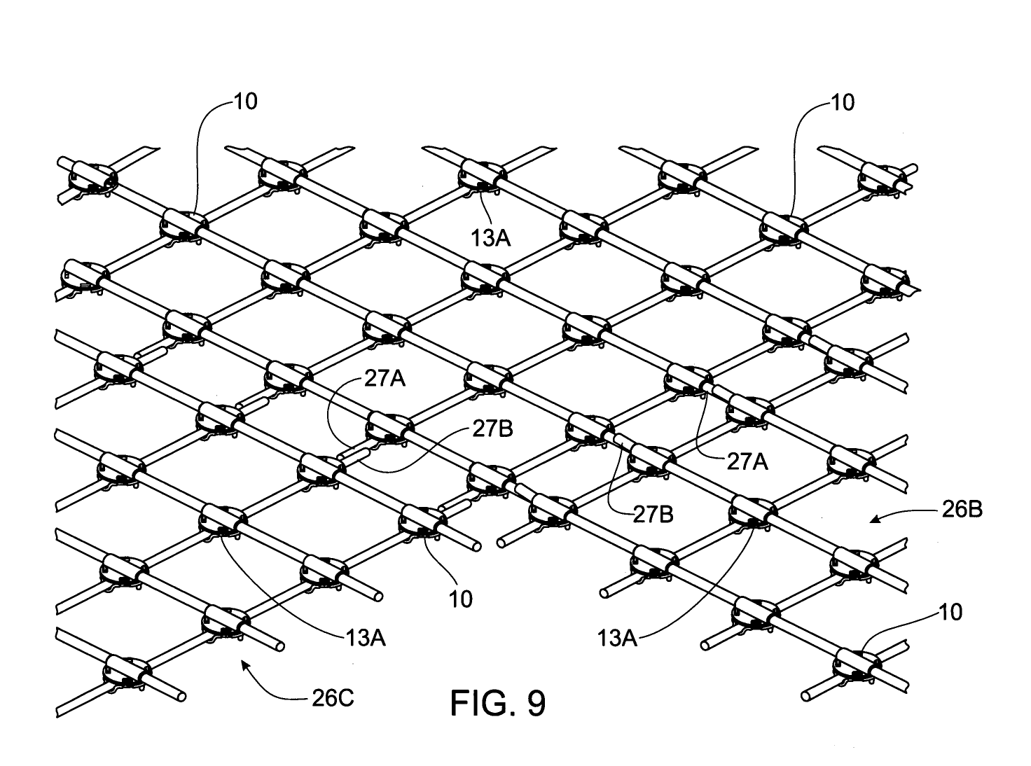

FIG. 9 is a perspective view of the sheet of reinforcement mesh shown in FIG. 8;

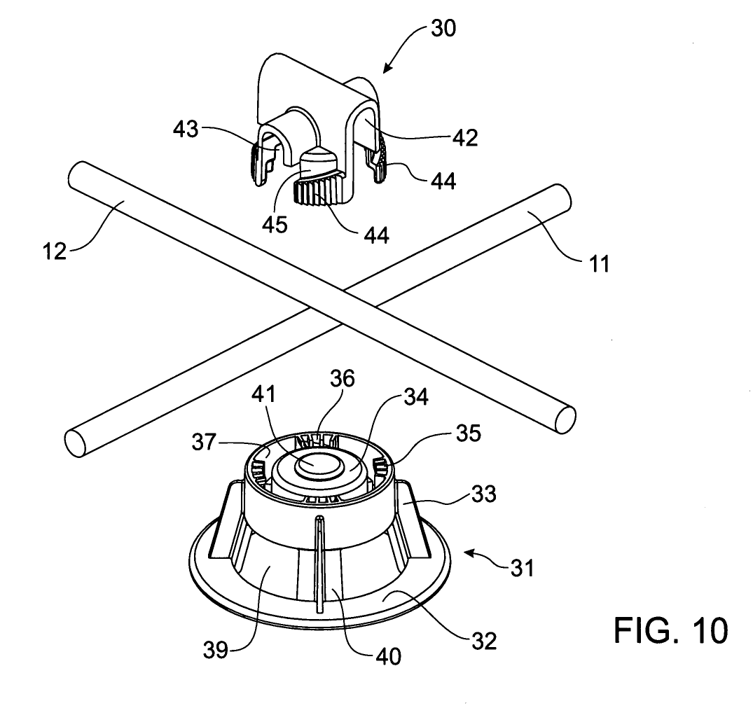

FIG. 10 is an exploded perspective view of a different connection method to that shown in FIG. 1;

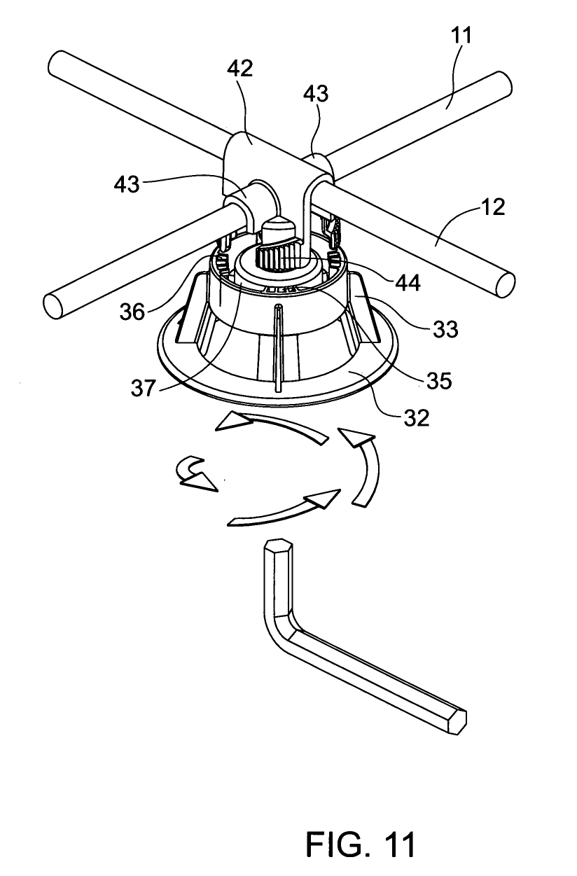

FIG. 11 shows a similar view as shown in FIG. 10 with both the upper and lower filament attached to the top support;

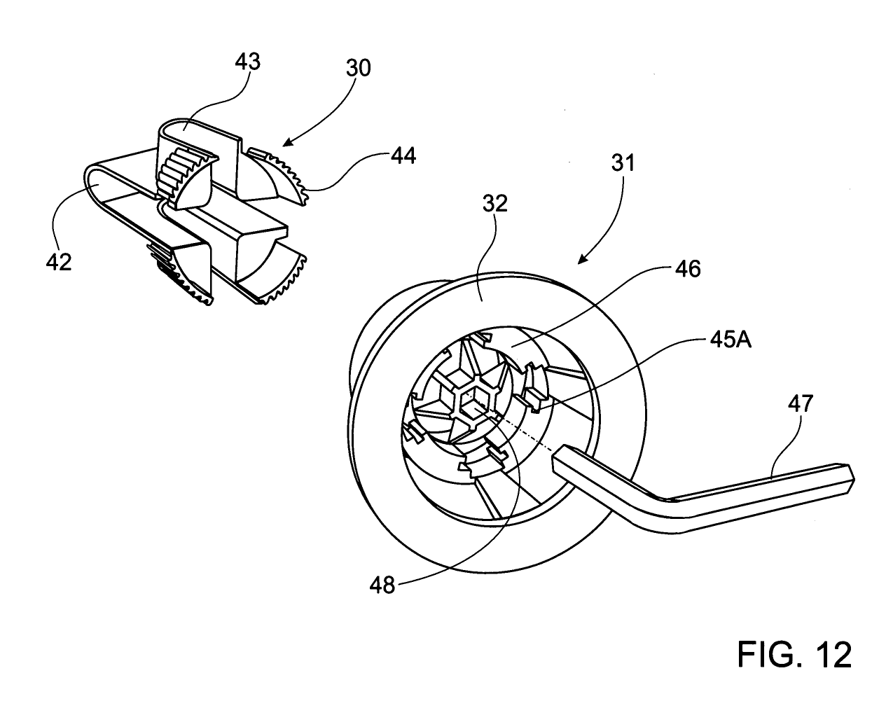

FIG. 12 shows an exploded view of both top support and bottom support showing from the underside showing how each of the top support and bottom support are attached to each other; in regard to the embodiment of FIG. 10;

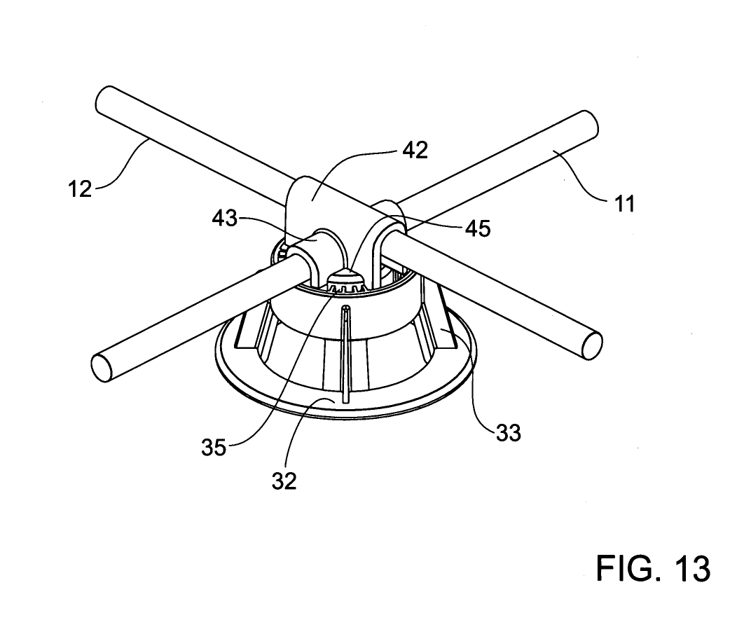

FIG. 13 shows an assembled view of upper and lower filament together with top support and bottom support using the correction method of FIG. 10;

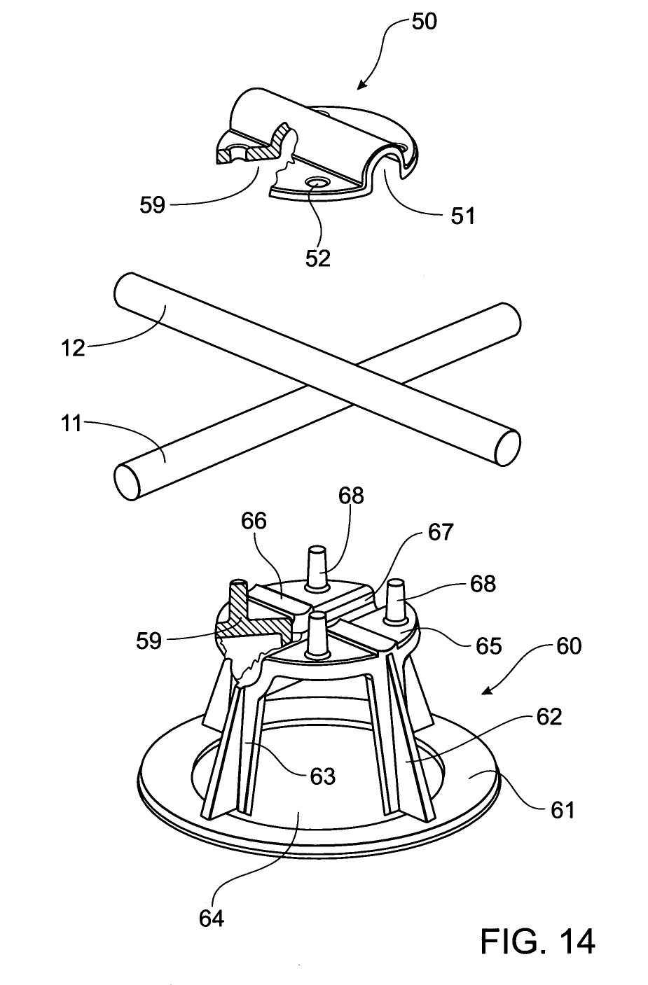

FIG. 14 shows a similar view to that shown in FIG. 10 but having regard to a different connection method;

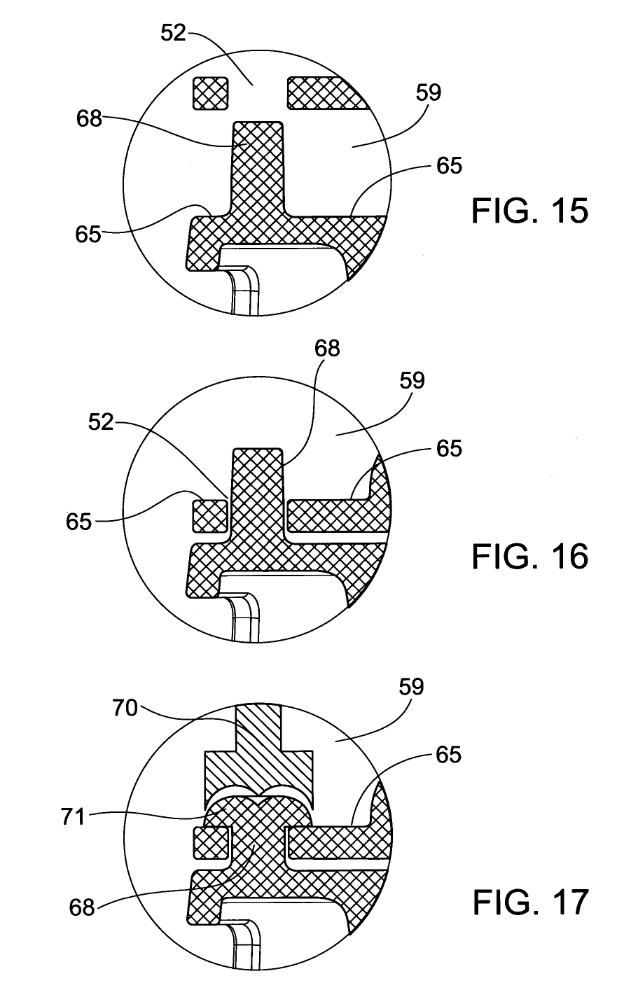

FIGS. 15-17 represent steps involved in the method of FIG. 14; and

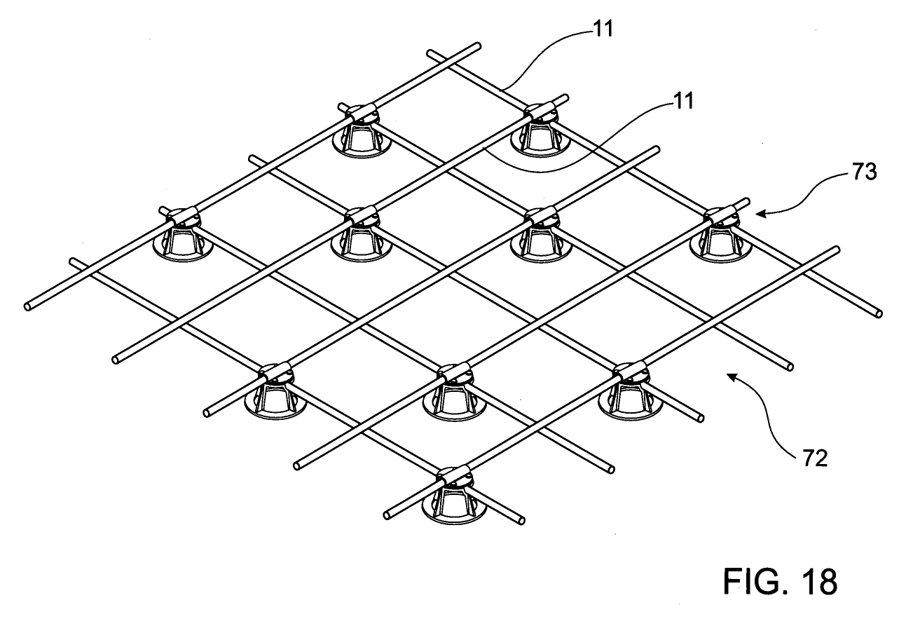

FIG. 18 shows a sheet of reinforcement mesh formed by the connection method shown in FIG. 14.

In FIG. 1 there is shown an exploded view of a top support clip 10, intersecting filaments 11 and 12 and bottom support clip 13 in the form of a 50 mm bar chair having an upper surface which has been modified to engage with top support clip 10. In this arrangement top support clip 10 is provided with an arcuate groove 14 and spaced sockets 15 arranged around the periphery of each wing or planar portion 16. The bottom support clip 13 is in the form of a bar chair having feet or upstanding planar parts or sections 17 which all have a bottom surface 18 for engaging the ground. The upper surface 19 of bar chair 13 has a lower groove 19 and opposed upper grooves 20 and 21. There is also provided upstanding projections or spigots 22 having an engagement tab or lip 23 wherein spigot 22 engages with a corresponding socket 15 with tab 23 passing through socket 15 and then engaging in snap fit relationship with socket 15 as shown in FIG. 3 with tab 23 abutting top surface 24 of wing 16 as shown.

FIG. 2 shows a similar view to FIG. 1 but with an important modification in that in clip assembly 9A the bottom support clip 13A is similar in structure to top support clip 10. Thus, bottom support clip 13A has grooves 19, 20 and 21 as described above and spigots 22 having tabs 23. There is also provided legs 25.

In another alternative there may be provided a top support clip 10 and a bottom support clip 13 or 13A which is integrally moulded with each filament 11 and 12 as shown in International Publication WO 2007/051253. Alternatively, each of top support clips 10 may be integrally moulded with filaments 11 and each of bottom support clips 13 or 13A may be integrally moulded with filaments 12 before being connected to each other as shown in FIG. 3.

FIG. 4 shows an assembled view of top support clip 10 and bottom support clip 13A and FIGS. 5, 6 and 7 respectively show a 50 mm chair suitable for forming concrete slabs of 100 mm thickness using top support clip 10 and bottom support clip 13, a 75 mm chair suitable for forming concrete slabs of 150 mm thickness using top support clip 10 and bottom support clip 13B and finally a 100 mm chair suitable for forming concrete slabs of 200 mm thickness using top support clip 10 and bottom support clip 13C.

In FIGS. 8 to 9 are shown a final step of attaching adjacent sheets to each other whereby adjacent sheets 26A, 26B and 26C are attached by ties 9 being tied around abutting ends 27A and 27B as shown in FIG. 8. Alternatively, clips or clamps may be used for securing attachment of abutting ends 27A and 27B. FIG. 9 shows the connection of adjacent sheets 26A, 26B and 26C on a perspective or three dimensional basis.

Thus, it will be appreciated from FIGS. 1 to 3 that both bottom support clip 13A engage with corresponding top support clips 10 in snap fit relationship as described above to firmly clamp intersecting filaments 11 and 12 to each other so as to form a sheet of mesh 26A, 26B and 26C shown in FIGS. 8 to 9. It is of course within the scope of the invention that when bar chairs are used in the method of the invention that bottom support clip 13A may be attached to a supporting bar chair (not shown) by plug socket engagement. However, it is preferred that when using bar chairs that bar chairs 13, 13B and 13C are utilised which are integrally moulded so as to have grooves 19, 20 and 21 and spigots 22.

It is also within the scope of the invention that top support clips 10 may instead of having engagement sockets 15 may be provided with spigots which engage with mating sockets on bottom support clips 13, 13A, 13B and 13C.

Reference may now be made to another embodiment shown in FIGS. 10-13 wherein there is shown a bottom support clip 31 in the form of a bar chair having base flange 32 and legs or upright flanges 33. Bottom support chip 31 also includes central boss 34 and as well as a plurality of sets 35 of engagement ribs 36. There are also provided spaces or gaps 37 between each set 35 of engagement ribs 36. There is also provided an upper side wall 38 and spaces 39 between each upright flange 33 which has a vertical inner part 40. Boss 34 also has a central raised portion 41.

There is also shown a top support clip 30 which has an upper retaining groove 42 and lower retaining grooves 43 located on each side of retaining groove 42. There is also provided a multiplicity of corrugated retaining members 44 and a web 45 between each retaining member 44 and upper retaining groove 42.

In FIG. 10 there are shown in exploded relationship bottom support clip 31, top support clip 30 and intersecting filaments 11 and 12. Top filament 12 locates in groove 42 and lower filament 11 locates in opposed grooves 43 as shown in FIG. 11. Top support clip 30 is shown spaced from bottom support clip 31 with each corrugated retaining member 44 about to be inserted in an adjacent space 37. Each of corrugated members 44 after insertion into an adjacent space 37 are retained in position by a retaining lug 46 having an inner recess 45 best shown in FIG. 12. After each corrugated part 44 is located in a respective recess 45A top support clip 30 is then rotated relative to bottom support chip 31 as shown be the arrows in FIG. 11 so that each corrugated member 44 abuts and engages a corresponding retaining member 36. This rotation may be carried out manually or by assistance of an Allen Key 47 which may engage engagement aperture 48 as shown in FIG. 12. Engagement aperture 48 has a closed end formed by raised portion 41. Finally top support clip 30 is shown firmly engaged with bottom support clip 31 as shown in FIG. 13 with both top filament 12 and bottom filament 11 firmly engaged as shown.

There is provided a further embodiment shown in FIGS. 14-18 where there is provided a top support clip 50 having a central downwardly directed retaining groove 51 and a plurality of retaining apertures 52. There is also provided a bottom support clip 60 in the form of a bar chair having a round base flange 61, upstanding legs or vertical supports 62, inner reinforcement parts 63, spaces 64 between adjacent vertical supports 62, and a top surface 65 having upper opposed retaining grooves 66 and a lower retaining groove 67 oriented normally thereto. There is also provided upstanding spigots or pins 68. There is also shown a section cut away at 59 which is illustrated in FIGS. 15-17. It will be appreciated that upper filament 12 engages in retaining groove 51 as well as opposed retaining grooves 66. Lower filament 11 engages in retaining groove 67. Thus each of filaments 11 and 12 engage with top support clip 50 and bottom support clip 60 in a manner similar to that shown in the FIG. 1 embodiment.

The feature of the FIGS. 14-18 embodiment is that spigots 68 engage with associated apertures 52 and this may occur as shown in FIG. 15-17 wherein sectional views are shown in sequence showing the sequence of steps involved in engagement of spigots 68 with an associated aperture 52 wherein spigot 68 is first inserted into aperture 52 and protrudes through aperture 52 as shown in FIGS. 15-16. After spigot 68 has been located in aperture 52 a heated staking tool 70 is then applied to spigot 68 and after application thereto spigot 68 is then swaged about top surface 65 of bottom support chip 60 as shown in FIG. 17 forming swaged portions 71.

FIG. 18 shows a sheet 72 of filaments 11 and 12 each of which are supported and attached to bar chair assemblies 73 as described in FIGS. 15-17.

It is also within the scope of the invention that intersecting filaments 11 and 12 be integrally moulded to a connection member or support member as shown in International Publication WO 2007/05123. However, use of a manual clipping method as shown in FIGS. 1-3 or FIGS. 10-13 is preferred because of a greater structural integrity to the resulting mesh sheet.

The invention also includes within its scope a mesh reinforcement sheet when made by the abovementioned method as well as the mesh sheet per se being a single sheet or a plurality of sheets all orientated in a single plane.

1. A method of formation of reinforcement mesh which includes the steps of:
(i) attaching intersecting filaments to each other using a bottom support and a top support wherein each of said filaments at a point of intersection is integrally moulded with the bottom support and/or top support or alternatively is supported by the bottom support or top support in a clipped or clamped relationship; and
(ii) attaching the bottom support and top support to each other to form said sheet of reinforcement mesh.

2. A method as claimed in claim 1, wherein adjacent sheets of reinforcement mesh formed of intersecting filaments are attached to each other in a single plane.

3. A method as claimed in claim 1, wherein there is provided a multiplicity of upper filaments and a multiplicity of lower filaments and each of the upper filaments is integrally moulded with the top support and each of the lower filaments are integrally moulded with the bottom support.

4. A method as claimed in claim 1, wherein there is provided a multiplicity of upper filaments and a multiplicity of lower filaments and each of the upper filaments are engaged in a clipped or clamped relationship by the top support and each of the lower filaments are engaged by the bottom support in clipped or clamped relationship before attachment of the top and bottom support to each other.

5. A method as claimed in claim 4, wherein each top support has a single retaining groove for retention of an adjacent upper filament and each bottom support has a single retaining groove for retention of an adjacent lower filament.

6. A method as claimed in claim 5, wherein each bottom support has additional retaining grooves on a top surface therefore which also engage with an adjacent top filament.

7. A method as claimed in claim 1, wherein the bottom support and top support are attached to each other in a clipped or clamped relationship.

8. A method as claimed in claim 7, wherein each of the bottom support and top support are attached to each other in a spigot-socket relationship.

9. A method as claimed in claim 8, wherein the bottom support has upstanding spigots or projections each having an engagement tab or lip wherein when a respective spigot engages a respective socket said engagement tab or lip passes through an adjacent socket before engaging in snap fit relationship with an adjacent surface of the top support.

10. A method as claimed in claim 1, wherein there is provided a multiplicity of upper filaments and a multiplicity of lower filaments and the top support has a single upper retaining groove for retention of an adjacent upper filament and also a single lower retaining groove for retention of a respective lower filament.

11. A method as claimed in claim 10, wherein the top support has a plurality of retaining members which each engage with a corresponding retaining member of the bottom support after relative rotation between the top support and bottom support.

12. A method as claimed in claim 11, wherein each retaining member of the top support is a corrugated lug and each corresponding retaining member of the bottom support is also a corrugated socket member.

13. A method as claimed in claim 5, wherein the bottom support has a plurality of upstanding engagement lugs which extend through corresponding apertures in the top support member before each engagement lug is swaged around an adjacent aperture by a swaging tool so as to contact a top surface of the top support member.

14. A sheet of reinforcement mesh when made by the method of claim 1.

15. A sheet of reinforcement mesh as claimed in claim 14, wherein adjacent sheets of reinforcement mesh are attached to each other in a single plane by ties, clamps or clips.
